(19) United States
(12) Patent Application Publication
(10) Pub. No.: US 2006/0150922 A1
(43) Pub. Date: Jul. 13, 2006

(54) Portable pet transportation device

(76) Inventor: Kevin J. Kroculick, Harrisburg, PA (US)

Correspondence Address: Kevin J. Kroculick, 115 Ringneck Drive, Harrisburg, PA, 17112, US

(21) Appl. No.: 11/032,862

(22) Filed: Jan. 11, 2005

(51) Int. Cl. A01K 1/035

(52) U.S. Cl. 119/771; 119/753

(57) ABSTRACT

A portable pet transportation device that provides additional surface area and space for supporting and transporting a pet, and especially a medium or large size pet, on the seat of an automotive vehicle, includes a platform of a thin, lightweight, rigid configuration that is disposed on the vehicle's seat with a portion of the platform snugly inserted at the interface of the back rest and the seat rest of the seat, and an opposite portion of the platform projecting in a cantilevered manner past the seat and above the vehicle floor creating a storage space between the cantilevered portion and the vehicle floor with the platform configured so as to avoid damaging the vehicle seat when disposed thereupon and of sufficient size to accommodate thereon a typical pet nest, blanket or pet carrier for the pet to lie in.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

(1) Field of the Invention

The present invention pertains to support and transportation devices, and more particularly pertains to a portable transportation device capable of supporting medium and large-sized pets thereon while they are being transported in automotive vehicles.

(2) Description of Related Art Including Information Disclosed Under 37 CFR 1.97 and 1.98.

Many people have pets, especially medium and large-sized dogs. It is well known that dogs have an affinity for riding in automotive vehicles; and, in addition, numerous occasions arise where pet owners must transport their pets in their vehicles. Such trips can range from visits to the veterinary office, travel and vacation excursions, conveyance to a local park or state park walking trail, and the like.

However, transporting the pet in the automotive vehicle can be an unpleasant experience for both the pet and the pet owner. In many instances the pet cannot be comfortably situated in the vehicle because the average seat in the typical car, truck, sport utility vehicle, or van is slightly smaller than the required space the pet needs to lie down—especially if the pet is a medium or large-sized dog breed such as a collie, Labrador retriever, or German Shepard. In addition to the problems and difficulties attendant on comfortably and safely situating the pet on the vehicle seat is the ancillary problem of the vehicle's seat becoming dirty, torn, matted with pet hair or otherwise damaged during the process of loading and transporting the pet.

Thus, the prior art discloses a number of devices for disposition on the vehicle seat, or for use as a supplemental seat, in order to transport pets.

For example, the Wallace patent (U.S. Pat. No. 4,969,683) discloses a vehicle seat protector for transporting animals with the animal situated on the seat and the seat protector.

The Edwards patent (U.S. Pat. No. 5,479,892) discloses a vehicle safety seat for pets that includes a base that sits on a vehicle seat but does not overhang the seat to provide additional area so that a medium or large-size pet can lie down and relax upon the base.

The Dean patent (U.S. Pat. No. 5,487,361) discloses a supplemental auto seat for use by an animal, and includes a horizontal seat component and a vertical seat component. The horizontal seat component overhangs the vehicle seat with the horizontal seat component being supported in its overhang by a pair of vertical legs that extend to and contact the vehicle floor.

The Fricano patent (U.S. Pat. No. 5,685,568) and Wright patent (U.S. Pat. No. 6,688,365) discloses a canine car seat having a cylindrical housing that sits on the car seat and does not overhang the seat. A seat belt is tightened about the housing in order to secure the housing to the seat for transporting the pet.

The Edwards patent (U.S. Pat. No. 5,123,377) discloses a collapsible vehicle safety restraint and seat for pets. The device has a pair of lateral restraints and a backrest, making the device somewhat complicated and limits it usefulness to smaller pets.

The Reese design patent (U.S. des. Pat. No. 461,966) and the Stump design patent (U.S. des. Pat. No. 376,447) each disclose an animal automobile seat having a base that sits on the vehicle seat and a raised platform atop the base.

The Edwards, Fricano, Reese, Wright, and Stump patents each disclose a type of animal seat that rests on the vehicle seat but does not overhang the vehicle seat to create or provide an additional storage area beneath the overhanging portion of the vehicle seat. This generally limits the usefulness of such animal seats to small, or, at best, medium-sized animals. There is also the problem that these devices are relatively difficult and expensive to manufacture and distribute. In addition, the Dean reference discloses an overhanging horizontal seat component supported by legs that extend down to and contact the vehicle floor. The legs take up valuable floor space that could be used for transporting animal supplies or any other items. The removable legs further complicate the manufacture of the device and may hinder quick installation and removal of the device. Moreover, the height of vehicle seats for automobiles, trucks, and vans will vary, thereby making it preferable to eliminate the need for the leg supports.

Nonetheless, despite the ingenuity of the above devices, there is a need for an animal transportation device that is easy to use, transport, and store, and upon which any medium and large-sized pet can be comfortably supported, and which creates an additional storage area by the configuration of the device and its disposition on the vehicle seat.

### BRIEF SUMMARY OF THE INVENTION

The present invention comprehends a lightweight, portable pet transportation device for supporting thereon medium and large-size animals, and especially medium and large-size pets, so that the animals can be transported within an automotive vehicle. The portable pet transportation device of the present invention includes a platform of uniform thickness that is uniquely shaped to provide maximum surface area for supporting the pet, as well as extending the surface area of the vehicle seat. The platform includes a securing portion, a body portion and an extension portion all of which are axially aligned and further defined by a peripheral border that includes rounded portions for preventing the platform from damaging the seat. The portable pet transportation device does not need a vertical back portion that would require structure to mount it to the seat backrest or associated hinged leg supports—both of which complicate the manufacture and use of the device.

It is an objective of the present invention to provide a portable pet transportation device that is easy and simple to use, inexpensive to manufacture and which can be quickly disposed for use on the automotive vehicle seat.

It is another objective of the present invention to provide a portable pet transportation device that effectively extends and enlarges the vehicle seat area of the typical automotive vehicle so that medium and large-sized pets can be comfortably supported and transported thereon.

It is yet another objective of the present invention to provide a portable pet transportation device that considerably extends the vehicle seat thereby increasing the overall area upon which the pet can be situated for transport in the vehicle.

It is a further objective of the present invention to provide a portable pet transportation device that gives the pet more area to relax and sleep, and therefore makes the pet more comfortable during transportation.

It is still yet another objective of the present invention to provide a portable pet transportation device that makes the pet more comfortable during transportation.

Still another objective of the present invention is to provide a portable pet transportation device that does not take up valuable floor space in the vehicle when being used.

Still yet another objective of the present invention is to provide a portable pet transportation device that protects the vehicle seat from dirt, scratches, tears and other such damage that could be caused by the pet or the installation and removal of the device.

A still further objective of the present invention is to provide a portable pet transportation device that makes pet transportations less difficult and stressful for both the pet and the pet owner.

A still yet further objective of the present invention is to provide a portable pet transportation device that conforms to the concave shape of automotive vehicle seats.

These and other objects, features and advantages will become apparent to one skilled in the art upon a perusal of the following detailed description read in conjunction with the accompanying drawing figures.

### BRIEF DESCRIPTION OF THE SEVERAL VIEWS OF THE DRAWINGS

FIG. 1 is a top plan view of the portable pet transportation device of the present invention;

FIG. 2 is a side elevational view of the portable pet transportation device of the present invention first shown in FIG. 1;

FIG. 3 is a perspective view of the portable pet transportation device of the present invention first shown in FIG. 1 illustrating the placement of the device within the automotive vehicle and upon the vehicle seat; and

FIG. 4 is a perspective view of the portable pet transportation device of the present invention first shown in FIG. 1 illustrating the disposition of the device upon the vehicle seat for supporting and accommodating thereon a pet of medium or large size.

### DETAILED DESCRIPTION OF THE INVENTION

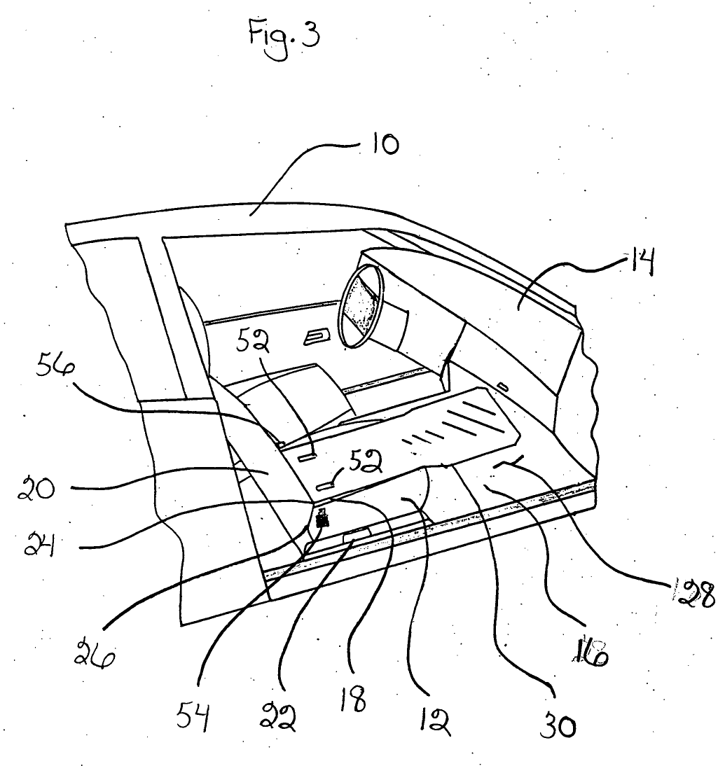

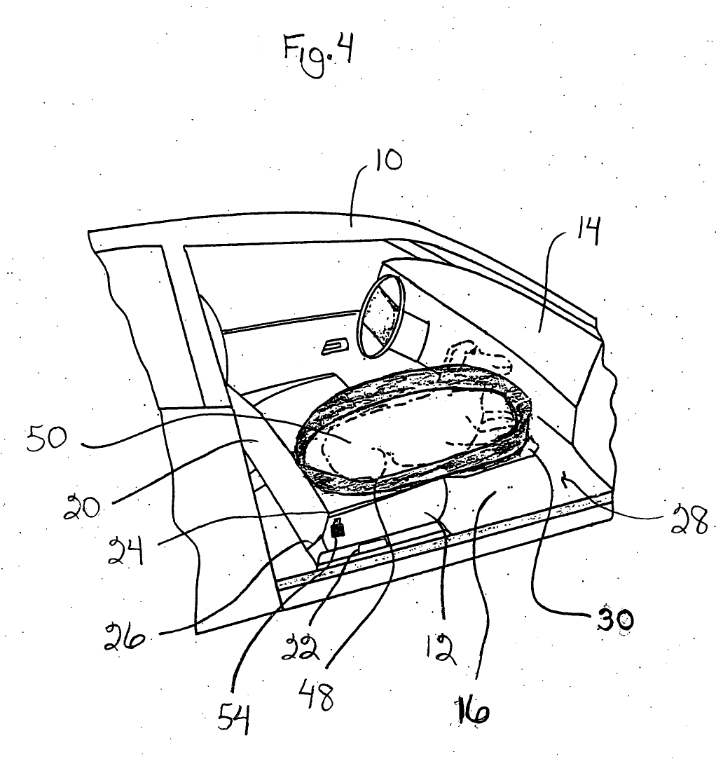

Illustrated in FIGS. 3 and 4 is a typical automotive vehicle 10 that includes a seat 12, a dashboard 14, and floor space 16. The seat 12 includes a seat rest 18, a back rest 20, a seat adjuster 22, and a seat interface 24 for the seat rest 18 and back rest 20. A fabric flap 26 attaches the seat rest 18 to the back rest 20. The floor space 16 is located above the vehicle floor 28 and in front of the seat 12.

Illustrated in FIGS. 1-4 is a preferred embodiment of the portable pet transportation device 30. The pet transportation device 30 includes an elongated platform 32 formed from thin, rigid, lightweight, resilient, planar material. The platform 32 is preferably manufactured from wood, rigid plastic, or fiberglass, and should be easily washable, and incorporate a scratch free surface. Other materials can be used, and the platform 32 can be manufactured from combinations of materials. In addition, an outer decorative covering for coordinating the device 30 with the interior of the particular vehicle 10 can be provided if desired. The elongated platform 32 is formed from three sections or portions each of which performs a specific function in supporting and comfortably transporting the animal upon the vehicle seat 12.

The portable pet transportation device 30 is shaped to generally conform to the seat rest 18 of the vehicle 10 and includes a smooth upper planar pet supporting surface 34 and an opposite smooth planar seat surface 36. Further, the platform 32 includes rounded edges 38 to avoid damaging the seat 12 when the device 30 is disposed thereon.

As shown in FIGS. 1-4, the platform 32 includes an extension portion 40 that is integrally adjoined to a body portion 42, and the extension portion 40 has a width that is greater than that of the body portion 42. In addition, a securing portion 44 is integrally adjoined to the body portion 42; and, as shown in FIG. 1, the extension portion 40, the body portion 42, and the securing portion 44 are axially aligned with each other. A preferred dimension for the device 30 is for the platform 32 to be at least 33 and ½ inches long and at least 18 and ½ inches wide at the extension portion that would define the platform's 32 widest area. The platform 32 tapers from the extension portion 40 down to the securing portion 44 so that the width of the securing portion 44 at a seat interface edge 46 of the securing portion is 12 inches. The platform 32 should have a constant thickness of at least ¼ of an inch to allow for ease of manufacture and to provide for the uniformly flat upper and lower surfaces 34 and 36. In addition, other dimensions for the preferred embodiment of the device 30 would be for the extension portion 40 to have an axial length of at least 13 and ½ inches and the combined length of the body portion 42 and the securing portion 44 being at least 20 inches thereby giving the platform 32 the length of at least 33 and ½ inches long as stated above. Furthermore, the width where the body portion 42 is integrally adjoined to the extension portion 40 should be at least 14 inches.

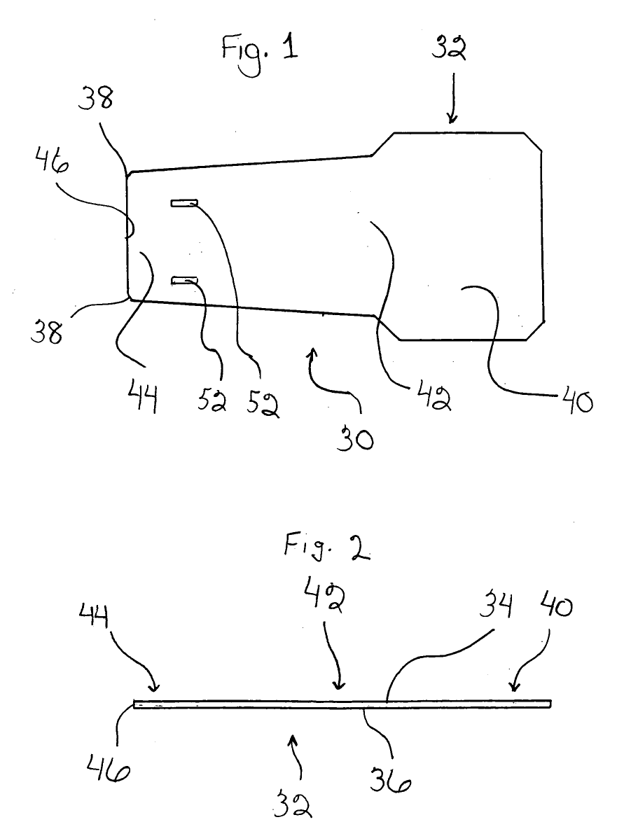

As illustrated in FIGS. 3 and 4, in order to install the portable pet transportation device 30 the individual should first adjust the seat 12 rearward by using the seat adjuster 22 thereby providing maximum floor space. The platform 32 is then placed over or upon the seat rest 18 so that the seat interface edge 46 of the securing portion 44 can be snugly inserted into the seat interface 24 as shown in FIG. 2. The body portion 42 and the securing portion 44 is in contact with and supported upon the seat rest 18 with the extension portion 40 projecting beyond the seat rest 18 so that the extension portion 40 freely overhangs from seat rest 18 and projects above the vehicle floor 28. The pet transportation device 30 is illustrated in FIGS. 3 and 4 as being installed upon the seat 12 that is the front vehicle seat, but the device 30 would be installed in a similar manner in the vehicle back seat.

When the device 30 is installed upon the vehicle seat rest 18, the extension portion 40 functions, in effect, as a cantilever beam in projecting beyond and overhanging the vehicle seat rest 18. This cantilevered extension defines a storage area beneath the extension portion 40 and enables the entire vehicle floor 28 beneath the cantilevered extending portion 40 to be used as a storage area as leg supports are unnecessary; and also maximizes the planar area on which the animal is transported.

In use a pet carrier 48, such as the 28-inch dog bed or dog nest shown in FIG. 4, and which is available in many pet stores and from pet supply catalogs, is placed upon the platform 32 of the pet transportation device 30. Other types of pet carriers, such as cages or boxes, can also be used. The pet carrier 48 is supported against the back rest 20 of the seat 12, and extends onto and is supported upon the extension portion 40 that overhangs the front of the seat 12. The pet 50 can sit, lie, or otherwise snuggle comfortably in the pet carrier 48; another arrangement would be to substitute a blanket for the pet carrier 48.

The pet transportation device 30 can easily support a dog nest or other pet carrier, such as pet carrier 48, that is larger than the seat rest 18 because extension portion 40 extends beyond the edge of the seat rest 18 and can therefore support that portion of the pet carrier 48 that would otherwise extend unsupported past the seat rest 18. Thus, the pet transportation device 30 can easily support and transport both a large pet, and the pet carrier, that would normally be too large for the seat 12, without using up the valuable floor space 16 in front of the seat 12. The entire floor space 16 beneath the cantilevered extension portion 40 is thus made available for storing and transporting pet supplies or any other items.

Depending on the position of the pet 50, the weight of the pet 50 and the pet carrier 48 urges the platform 32 to rotate clockwise as shown in FIG. 4 thereby causing the seat interface edge 46 and the securing portion 44 to slightly lift up off the seat rest 18 and contact the back rest 20. When the seat interface edge 46 and the securing portion 44 contact and engage the back rest 20, further rotation of the platform 32 will be halted and the pet transportation device 30 will be maintained in position on the seat rest 18 with the body portion 42 remaining in contact with the seat rest 18. In addition, the frictional resistance between the platform 32 and the seat interface 24, and more specifically between the seat interface edge 46 and the upper and lower surfaces 34 and 36 that form the part of the securing portion 44 adjacent to the seat interface edge 46, causes the pet transportation device 30 to resist lateral motion upon the seat rest 18 of the seat 12 during vehicle 10 deceleration.

In most instances, the pet transportation device 30 can be snuggly inserted into the space defined by the seat interface 24. However, if the fabric flap 26 prevents the seat interface edge 46 and the securing portion 44 from being fully inserted into the seat interface 24, or anytime a snug fit cannot be achieved, the pet owner still has a means to secure the device 30 to the seat rest 16 of the seat 12. Specifically, the securing portion 44 includes a pair of spaced-apart slots 52 that are sized to allow the passage therethrough of the vehicle seat belt 54 so that the seat belt 54 can be attached to the seat belt lock 56. Thus, the pet owner can pass the seat belt 54 through both slots 52 for locking the seat belt 54 to the seat belt lock 56 thereby securing the device 30 in place upon the seat rest 18 of the seat 12.

While the invention has been described in terms of a single preferred embodiment, those skilled in the art will recognize that numerous modifications, alterations, and variations are possible and practicable while still remaining within the spirit of the invention and the scope of the appended claims.

### SEQUENCE LISTING

Not applicable.

I claim:

1. A portable pet transportation device for disposition on the seat rest and adjacent the seat interface and back rest of a seat of an automotive vehicle for supporting and transporting an animal thereon, comprising:
an elongated platform having an upper planar animal supporting surface and an opposite planar seat surface that is disposed in partial contiguous contact with the seat rest of the seat;
the elongated platform further comprising: an extension portion that projects beyond the seat rest;
a body portion axially aligned with the extension portion and integrally adjoined thereto;
a securing portion integrally adjoined to the body portion and in axial alignment therewith;
the securing portion having a seat interface edge for insertion into the seat interface of the seat;
a peripheral border extending about the extension portion, the body portion and the securing portion with the peripheral border including a plurality of rounded edges to avoid damage to the seat when the platform is disposed thereon;
the extension portion having a width that is greater than the width of the body portion and the securing portion for comfortably supporting the pet thereon; and
whereupon for mounting the platform to the seat the seat interface edge of the securing portion is inserted into the seat interface so that the body portion rests upon the seat rest and the extension portion projects past and overhangs the seat rest so that the animal can be comfortably supported upon the securing portion, the body portion and the extension portion of the platform with the weight of the animal causing the simultaneous downward pivotal motion of the extension portion and the upward pivotal motion of the securing portion resulting in the securing portion engaging the back rest of the seat to thereby further secure and maintain the platform in position on the seat of the automotive vehicle.

2. The portable pet transportation device of claim 1 wherein the lateral movement of the platform on the seat during automotive vehicle deceleration is minimized by the frictional resistance of the securing portion against the seat interface.

3. The portable pet transportation device of claim 2 wherein the securing portion includes a pair of opposed slots with each slot adjacent the peripheral border and each slot sized to permit passage therethrough of the seat belt for the seat.

4. The portable pet transportation device of claim 3 wherein the seat belt is inserted through both slots for attachment to the seat belt lock thereby securing the platform to the seat of the automotive vehicle.

5. The portable pet transportation device of claim 4 wherein the platform can comfortably accommodate thereon a medium size or large size animal.

6. The portable pet transportation device of claim 5 wherein the platform has a thickness of at least ¼ of an inch.

7. The portable pet transportation device of claim 6 wherein the platform is constructed out of materials that may include wood, rigid plastic and fiberglass.

8. A portable pet transportation device for disposition on the seat rest and against the seat interface and back rest of a seat of an automotive vehicle for supporting and transporting a pet, comprising:
an elongated platform having an upper planar pet supporting surface and an opposite planar seat surface wherein the planar seat surface is disposed in partial contiguous contact with the seat rest of the seat;
the elongated platform further comprising: an extension portion that projects in a cantilevered manner past the seat rest;
a body portion axially aligned with the extension portion and integrally extending therefrom;
a securing portion axially aligned with the body portion and integrally extending therefrom;
the securing portion including a seat interface edge for insertion into the seat interface of the seat;
a peripheral border continuously extending about the extension portion, the body portion and securing portion and the peripheral border including a plurality of rounded edges so that the platform does not damage the seat when the platform is disposed thereon;
the extension portion having a width that is greater than the width of the body portion and the securing portion in order to accommodate and comfortably support thereon medium size and large size pets; and
whereupon in order to mount the platform on the seat the seat interface edge of the securing portion is inserted into the seat interface so that the body portion rests upon the seat rest and the extension portion projects in a cantilevered manner beyond the seat rest so that the pet is comfortably supported upon the securing portion, the body portion and the extension portion with the weight of the pet causing the simultaneous downward pivotal motion of the extension portion and the upward pivotal motion of the securing portion so that the securing portion engages the back rest of the seat thereby preventing the further pivotal motion of the securing portion and maintaining the platform in position upon the seat and the lateral movement of the platform on the seat during automotive vehicle deceleration is minimized by the frictional resistance of the securing portion against the seat interface.

9. The portable pet transportation device of claim 8 wherein the securing portion includes a pair opposed slots with each slot adjacent the peripheral border that extends about the securing portion and each slot sized to permit the insertion therethrough of the seat belt of the seat.

10. The portable pet transportation device of claim 9 wherein the seat belt is insertable through both slots for attachment to the seat belt lock in order to secure the platform in position upon the seat rest of the seat.

11. The portable pet transportation device of claim 10 wherein the platform can comfortably accommodate and support thereon a medium or large size pet.

12. The portable pet transportation device of claim 11 wherein the platform has a uniform thickness of at least ¼ of an inch.

13. The portable pet transportation device of claim 12 wherein the platform can be constructed from materials that include wood, rigid plastic and fiberglass.

14. The portable pet transportation device of claim 13 wherein the cantilevered projection of the extension portion past the seat rest creates a storage area in front of the seat rest of the seat and beneath the extension portion.

15. A portable pet transportation device for disposition on the seat rest and adjacent the seat interface and back rest of the seat in an automotive vehicle for supporting and transporting thereon a pet, comprising:
an elongated platform having an upper planar pet supporting surface and an opposite planar seat surface wherein at least a portion of the planar seat surface is disposed contiguous with the seat rest of the seat;
the elongated platform further comprising: an extension portion that overhangs in a cantilevered manner past the seat rest of the seat;
a body portion axially aligned with the extension portion and integrally adjoined to the extension portion;
a securing portion axially aligned with the body portion and integrally adjoined to the body portion;
the securing portion including a seat interface edge for insertion into the seat interface of the seat;
a peripheral border continuously extending about the extension portion, the body portion and the securing portion, and the peripheral border including a plurality of rounded edges so that the platform does not damage the seat when the platform is disposed thereon;
the extension portion having a width that is greater than the width of the body portion and the securing portion in order to more comfortably accommodate and support the pet on the extension portion;
a pair of opposed slots located on the securing portion so that a seat belt can be passed through the slots for locking the seat belt to the seat belt lock thereby securing the platform on the seat rest of the seat; and
whereupon for mounting the platform on the seat the seat interface edge of the securing portion is inserted into the seat interface so that the body portion rests upon the seat rest and the extension portion overhangs in a cantilevered manner past the seat rest so that the pet can be comfortably supported upon the upper planar supporting surface and the weight of the pet causing the simultaneous downward pivotal motion of the extension portion and the upward pivotal motion of the securing portion thereby bringing the securing portion in contact with the back rest of the seat for preventing further pivotal movement of the securing portion and maintaining the platform in position upon the seat so that lateral movement of the platform upon the seat rest of the seat during automotive deceleration is hindered by the frictional resistance between the securing portion and the seat interface.

16. The portable pet transportation device of claim 15 wherein the seat belt is insertable through both slots and then locked to the seat belt lock so that the seat belt is disposed over the securing portion for attaching the platform to the seat of the automotive vehicle and maintaining the position of the platform on the seat of the vehicle.

17. The portable pet transportation device of claim 16 wherein the platform has a uniform thickness of at least ¼ of an inch.

18. The portable pet transportation device of claim 17 wherein the platform can comfortably accommodate and support thereon a medium size or large size pet.

19. The portable pet transportation device of claim 18 wherein the platform can be constructed from materials that include wood, rigid plastic and fiberglass.

20. The portable pet transportation device of claim 19 wherein the cantilevered overhang of the extension portion past the seat rest creates a storage area in front of the seat and beneath the extension portion and increases the surface area upon which the pet is transported.

21. The portable pet transportation device of claim 20 wherein the extension portion has an axial length of at least 13 and ½ inches.

22. The portable pet transportation device of claim 21 wherein the combined axial length of the body portion and the securing portion is at least 20 inches.

23. The portable pet transportation device of claim 22 wherein the width of the extension portion is at least 18 and ½ inches.
